(19) United States
(12) Patent Application Publication
(10) Pub. No.: US 2020/0081269 A1
(43) Pub. Date: Mar. 12, 2020

(54) Apparatus, Method and System for Measuring the Influence of Ophthalmic Lens Design

(71) Applicant: Queensland University of Technology, Brisbane (AU)

(72) Inventors: Michael John Collins, Jollys Lookout (AU); Brett Ashley Davis, Holland Park (AU); Fan Yi, Stafford Heights (AU)

(21) Appl. No.: 16/493,948

(22) PCT Filed: Mar. 15, 2018
(86) PCT No.: PCT/AU2018/000034

§ 371 Date: Sep. 13, 2019

(30) Foreign Application Priority Data
Mar. 15, 2017 (AU) 2017900907

(51) Int. Cl. G02C 7/02; G01M 11/02

(52) U.S. Cl. CPC G02C 7/024; G01M 11/0271; G01M 11/0278

(57) ABSTRACT

A method for measuring an influence of an ophthalmic lens design is disclosed. The method comprises splitting an optical light beam into a wavefront measurement light path and a wavefront modulation light path; implementing the ophthalmic lens design in an adaptive optics device positioned in the wavefront modulation light path; and obtaining ocular biometric data in the ocular biometric and wavefront measurement light path to measure the influence of the ophthalmic lens design. Also disclosed are an apparatus and a system for measuring an influence of an ophthalmic lens design along with a method for assembling the device and system. The ocular biometric device may be an interferometer and the adaptive optics device may comprise one or more wavefront shapers.

### FIELD OF THE INVENTION

The present invention relates to an apparatus, method and system for implementing and measuring the influence of ophthalmic lens designs. More particularly, this invention relates to an apparatus, method and system comprising an adaptive optics device and an optical biometric device.

### BACKGROUND TO THE INVENTION

The correction of myopia by eye care practitioners has traditionally involved the use of lenses to bring light into sharp focus on the retina, thereby improving the quality of vision. This approach provides clear vision for the myopic patient, but does not slow or stop the progression of myopia. It is now evident that the growth of the human eye and the progression of myopia can be influenced by the optical characteristics of the retinal image.

The eyes of all animal species researched to date, show the capacity to detect the sign (direction) of defocus of light at the retina and to respond to it by growing towards the optimal focus. Hyperopic (negative) blur causes the eye to grow longer and myopic (positive) blur causes the eye to stop growing and in some cases to slightly shorten. This process of the eye growing to a length that focuses the image of light at the retinal plane is referred to as emmetropization, where the eye is growing to attain emmetropia and clear vision. Myopia (and hyperopia) arises when this emmetropization process fails to provide a close match between the axial length and the optical power of the eye to produce a clear retinal image and the eye grows too long for the image plane. In young children, the eye naturally grows longer and the optical power of the eye reduces so that by about the start of puberty, the eye has reached adult length and is emmetropic. However in myopic children, the eye grows rapidly and continues to grow during the teenage years.

What causes the myopic child's eye to continue to grow is not yet established. It reflects an apparent failure of the emmetropization process. Various theories have been proposed as to what might lead to a hyperopic cue for eye growth in the myopic child's eye. On the other hand, the introduction of myopic defocus into the retinal image of the myopic child's eye, has been proposed as a logical method to slow or stop excessive eye growth. While myopic defocus can slow eye growth, it also degrades vision.

Prospective clinical trials have shown that the rate of myopia progression in humans can be influenced by the optical design of soft contact lenses. These clinical trials have established that the introduction of positive defocus in the retinal image of children slows the progression of myopia. Changes in eye length associated with defocus are modulated by changes in both scleral growth and choroidal thickness, the net effect of which results in an anterior or a posterior movement of the retina toward the image plane. Induced myopic defocus, leads to a thickening of the choroid and to a decreased scleral growth rate (which results in anterior movement of the retina), and induced hyperopic defocus leads to a thinning of the choroid and an increase in scleral growth rate (which results in posterior movement of the retina). Choroidal thickness changes in response to imposed defocus have been observed in both avian and primate animal models, and have been demonstrated to occur rapidly and to precede longer term, sclera-mediated changes in eye size.

The introduction of precise methods for measuring eye dimensions has led to the finding that a number of factors can lead to short-term changes in optical axial length (the axial distance from the anterior cornea to the retinal pigment epithelium) of human subjects. Changes in accommodation and intra-ocular pressure have both been found to be associated with short-term changes in axial length and small but significant diurnal variations have also been noted to occur in human axial length, which are primarily mediated by changes in choroidal thickness.

Research has shown that in young adult human subjects, short-term changes in the choroid thickness and axial length occur in a way similar to that observed in other animal species in response to optical defocus. Studies investigating the time course of choroidal thickness changes in response to defocus, have illustrated that these changes occur within minutes of exposure. When the defocus is imposed for a day, it significantly disrupts the normal diurnal rhythms in choroidal thickness and axial length with predictable patterns of change depending on the sign of the defocus.

Optical designs for the control of myopia progression are currently based on the principle of incorporating positive power to focus light in front of the retina, while at the same time focusing some light on the retina to provide distance vision correction. This optical constraint leads to some loss of visual performance.

The presence of positive power in the retinal image therefore creates two competing outcomes, myopia control versus vision quality. Improved mechanisms of understanding how these competing factors interact are desired to optimize the optical design of lenses.

The reference to any prior art in this specification is not, and should not be taken as, an acknowledgement or any form of suggestion that the prior art forms part of the common general knowledge.

### OBJECT OF THE INVENTION

It is a preferred object of the embodiments of the present invention to provide an apparatus that addresses or at least ameliorates one or more of the aforementioned problems of the prior art and/or provides a useful commercial alternative.

### SUMMARY OF THE INVENTION

Generally, embodiments of the present invention relate to an apparatus, method and system for implementing and measuring the influence of an ophthalmic lens design.

In a broad form the invention relates to an apparatus, method and system comprising an adaptive optics device to implement an ophthalmic lens design. The influence of the ophthalmic lens design can be then be measured with an optical biometric device.

In a first form, although it need not be the only or indeed the broadest form, the invention provides a method for measuring an influence of an ophthalmic lens design comprising:
splitting an optical light beam into a wavefront measurement light path and a wavefront modulation light path;
implementing the ophthalmic lens design in an adaptive optics device positioned in the wavefront modulation light path; and
obtaining ocular biometric data in the ocular biometric measurement light path to measure the influence of the ophthalmic lens design.

In a second form, the invention provides an apparatus for measuring an influence of an ophthalmic lens design comprising:
a beam splitter which splits an optical light path into a wavefront measurement light path and a wavefront modulation light path;
an adaptive optics device positioned in the wavefront modulation light path to implement the ophthalmic lens design; and
an ocular biometric device positioned in the ocular biometric measurement light path to obtain ocular biometric data.

In a third form, the invention provides a system for measuring an influence of an ophthalmic lens design comprising:
a beam splitter for splitting an optical light path into a wavefront modulation light path and a wavefront measurement light path;
an adaptive optics device positioned in the wavefront modulation light path; one or more processor for controlling the adaptive optics device to implement the ophthalmic lens design; and
an ocular biometric device positioned in the ocular biometric measurement light path for obtaining ocular biometric data.

In a fourth form, the invention provides a method for assembling the device of the second form or the system of the third form, the method comprising:
installing a beam splitter to split an optical light path into a wavefront measurement light path and a wavefront modulation light path;
positioning an adaptive optics device in the wavefront modulation light path to implement the ophthalmic lens design;
when directed to a system, connecting one or more processor to control the adaptive optics device to implement the ophthalmic lens design; and
positioning an ocular biometric device in the ocular biometric measurement light path to obtain ocular biometric data.

In a fifth form, the invention provides an ophthalmic lens comprising the ophthalmic lens design implemented in the first form or the third form.

The ophthalmic lens of the fifth form may comprise a contact lens.

In a sixth form, the invention provides a method for optimising a lens design using the method of the first form, the apparatus of the second form or the system of the third form.

In a seventh form, the invention provides an ophthalmic lens comprising the optimised lens design of the sixth form.

According to any above form, the beam splitter may comprise any suitable device for splitting a light beam into two or more beams. The beam splitter may comprise a pellicle beam splitter, a cube beamsplitter, a dichroic mirror, a band filter or a longpass/shortpass filter.

According to any above form, the biometric device comprises a non-contact ocular biometric device. The ocular biometric device may comprise an interferometer. The interferometer may comprise a laser interferometer or a low coherence interferometer. The interferometer may comprise an optical biometer or an optical coherence tomographer (OCT).

According to any above form, the adaptive optics device comprises one or more wavefront shapers. The one or more wavefront shapers may comprise one or more spatial light modulator and/or one or more adaptive minor.

According to any above form, the spatial light modulator may be comprised of a liquid crystal layer that changes refractive index for optical modulation, in response to an array of underlying electrodes. The spatial light modulator may comprise square liquid crystal cells with a pixel or optical element size of 15×15 microns. The spatial light modulator may comprise a square 7.68×7.68 mm active area.

According to any above form, the spatial light modulator may be operated by a controller to adjust the shape of a generated wavefront.

According to any above form, the adaptive mirror may be driven by one or more actuators to adjust the shape of a generated wavefront.

According to any above form, the one or more wavefront shapers may comprise one or more spatial light modulators and/or adaptive minors in combination.

According to any above form, the adaptive optics device may further comprise a wavefront sensor.

According to any above form, the adaptive optics device may further comprise a plurality of optical elements. The plurality of optical elements may comprise a focus corrector. The focus corrector may comprise a Badal stage. The Badal stage may comprise two or more Badal stage mirrors. The plurality of optical elements may further comprise one or more relay lens set; one or more mirrors; one or more lenses; one or more beam splitters; and/or one or more cold minors.

According to any above form, the adaptive optics device may further comprise one or more micro-display. The one or more micro-display may comprise a primary micro-display and a secondary micro-display. The primary micro-display may be viewable through the two or more wavefront shapers. Each of the one or more micro-display may comprise any suitable display such as, an LED or OLED display.

Each of the one or more micro-displays may be individually or collectively synchronised to display vision tests including visual acuity and contrast sensitivity.

Each of the one or more micro-displays may also be individually or collectively synchronised to display a movie or collection of images of the viewer's choice.

According to any above form, each of the one or more micro-display may comprise a fine reference scale and/or a grayscale. The grayscale may comprise 256 levels.

According to any above form, the secondary micro-display may be aligned so that the image displayed thereon overlays with an image displayed on the primary micro-display. The images displayed on the secondary micro-display may be under independent optical control.

According to any above form, an image displayed on a micro-display may be manipulated with imposition of an optical design while the image displayed on the secondary display may be used as a reference.

According to any above form, the optical elements may comprise an objective lens in front of the secondary micro-display to produce the same through-system magnification as in the primary micro-display.

According to any above form, the adaptive optics device may further comprise an imaging device, such as a digital camera with its image plane conjugate to or replacing the retinal plane of the eye.

According to any above form, the method, apparatus, and system may further comprise an illumination source. The illumination source may comprise one or more LED. The one or more LED may be arranged in a ring.

According to any above form, the method, apparatus, and system may further comprise a lens mount and a lens positioned before the beam splitter.

According to any above form, the method, apparatus, and system may further comprise a pupil tracker system. A pupil viewer, such as a digital camera, may be positioned in a pupil tracking path. The pupil tracking path may comprise a pupil tracking beam splitter. The pupil tracking system may comprise a pupil tracker illumination source. The pupil tracker illumination source may illuminate at a near infrared wavelength. The near infrared wavelength may comprise 700 to 2500 nm; 800 to 1100 nm; or 900 to 1000 nm. In one embodiment the near infrared wavelength comprises 950 nm.

The apparatus and system may further comprise one or more superluminescent diode to create a point source of light at the retina for wavefront measurement.

The apparatus and system may further comprise a superluminescent diode for alignment

According to any above form, the method, apparatus, and system may further comprise a fellow eye 30OD display. The fellow eye display may be synchronised with a respective one or more micro-display.

According to any above form, the method, apparatus, and system may further comprise fellow eye optical elements. The fellow eye optical elements may comprise one or more of a lens and a colour filter. The fellow eye optical components, or a portion thereof, may be comprised in a fellow eye lens mount. The fellow eye optical elements may comprise a mirror between the fellow eye lens mount and the fellow eye display.

According to any above form, the method, apparatus and system may comprise a binocular method, apparatus and system comprising splitting, implementing and obtaining for both eyes. The binocular system also comprises controlling the adaptive optics device for both eyes.

The biometric data obtained may comprise one or more of: choroidal thickness; optical axial length (distance from the anterior corneal surface to the retinal pigment epithelium); vitreous chamber depth; anterior chamber depth; crystalline lens thickness; corneal thickness; retinal thickness (or layers within the retina); and scleral thickness. These biometric data may be acquired along any axis of the eye, but will typically be acquired along the visual axis as the person being tested views the biometer's fixation target.

Further aspects and/or features of the present invention will become apparent from the following detailed description.

### BRIEF DESCRIPTION OF THE DRAWINGS

In order that the invention may be readily understood and put into practical effect, reference will now be made to embodiments of the present invention with reference to the accompanying drawings, wherein like reference numbers refer to identical elements. The drawings are provided by way of example only, wherein:

FIG. 1A is a schematic diagram showing one embodiment of an apparatus according to the invention.

FIG. 1B is a schematic diagram illustrating a binocular apparatus according to one embodiment of the invention.

FIG. 1C is a schematic diagram illustrating another embodiment of an apparatus according to the invention.

FIG. 1D is a schematic diagram illustrating the subject view according to one embodiment of the invention.

FIG. 1E is a schematic diagram showing one embodiment of the system according to the invention.

FIG. 2A is a schematic diagram showing one embodiment of a computing device suitable for use according to one embodiment of the invention;

FIG. 2B is a schematic diagram showing one embodiment of a processor and memory suitable for use according to one embodiment of the invention.

FIG. 3A is a schematic diagram showing one embodiment of an adaptive optics device according to the invention.

FIG. 3B is a schematic diagram showing another embodiment of an adaptive optics device according to the invention.

FIG. 3C shows a visual target for visual acuity testing according to one embodiment of the invention.

FIGS. 4A and 4B are line graphs showing validation testing of the SLM.

FIG. 5 shows the effect of increasing the amplitude of plus power in the peripheral zone of a centre clear bifocal design on the subject's visual acuity.

FIG. 6 shows the contrast sensitivity of three letter sizes 0.3, 0.4 and 0.6 logMAR, affected by increasing peripheral power in a centre clear bifocal design.

FIG. 7 is a graphic illustration showing the effect of pupil tracking on the combined wavefront. The combined wavefront of a model eye and predetermined wavefront pattern was measured with and without pupil tracking. Two horizontal pupil offset conditions were tested (dx=0.25 and 0.5 mm). Significantly larger amount of residual wavefront error was found in non-tracked measurements.

FIG. 8 is a graph showing pupil tracking in a subject's eye. The pupil tracking was over 30 minutes. The subject's head was positioned on a chinrest without the use of a bite bar. The subject tried to stay as still as possible for the full 30 minutes. During the measurement, the subject blinked normally. The subject was allowed to close his eyes for 10 seconds after every 1 minute of measurement. The sampling frequency was about 4 Hz (some blinks missed due to sampling frequency).

FIG. 9 is a graphic showing the change of axial length using the movie task (top) and the Maltese cross task (bottom).

FIG. 10 shows a subject's axial length change during a 40 min blur task of viewing through different optical designs, including +3D defocus, −3D defocus, +3D longitudinal spherical aberration and −3D longitudinal spherical aberration.

FIG. 11 shows the average changes (N=16) of axial length during a 40 min blur task and a 20 min recovery period after viewing through different optical designs, including baseline, +3D defocus and a 2 zone bifocal with a 2.0 mm central clear and periph +6 D.

FIG. 12 is a flowchart showing the method according to one embodiment of the invention.

Skilled addressees will appreciate that elements in the drawings are illustrated for simplicity and clarity and have not necessarily been drawn to scale. For example, the relative dimensions of some elements in the drawings may be distorted to help improve understanding of embodiments of the present invention.

### DETAILED DESCRIPTION OF THE INVENTION

Embodiments of the present invention relate to an apparatus, method and system for implementing an ophthalmic lens design. Once implemented, the influence of the ophthalmic lens design can then be measured with an optical biometric device.

In one embodiment, the invention relates to a method, apparatus and system comprising an adaptive optics device and an optical biometric device for measuring the influence of ophthalmic lens design.

“Ophthalmic lens” as used herein refers to any lens for an eye or for wearing in front of an eye. The ophthalmic lens may be a corrective lens. The ophthalmic lens may be for treating myopia, hyperopia, astigmatism, presbyopia or any ophthalmic disease or condition. The ophthalmic lens may comprise glasses or spectacle lens/lenses, a contact lens, an intraocular lens or any form of ophthalmic lens.

As used herein a “wavefront shaper” is any adaptive optics device that can modify a wavefront. In the present invention, the wavefront shapers are used to modify a wavefront to implement an ophthalmic lens design by putting that ophthalmic lens design into effect.

Some of the important aspects of vision that the inventors anticipate to be impacted by the myopia control designs are visual acuity and contrast sensitivity. Therefore the inventors have placed importance on investigating these aspects of vision.

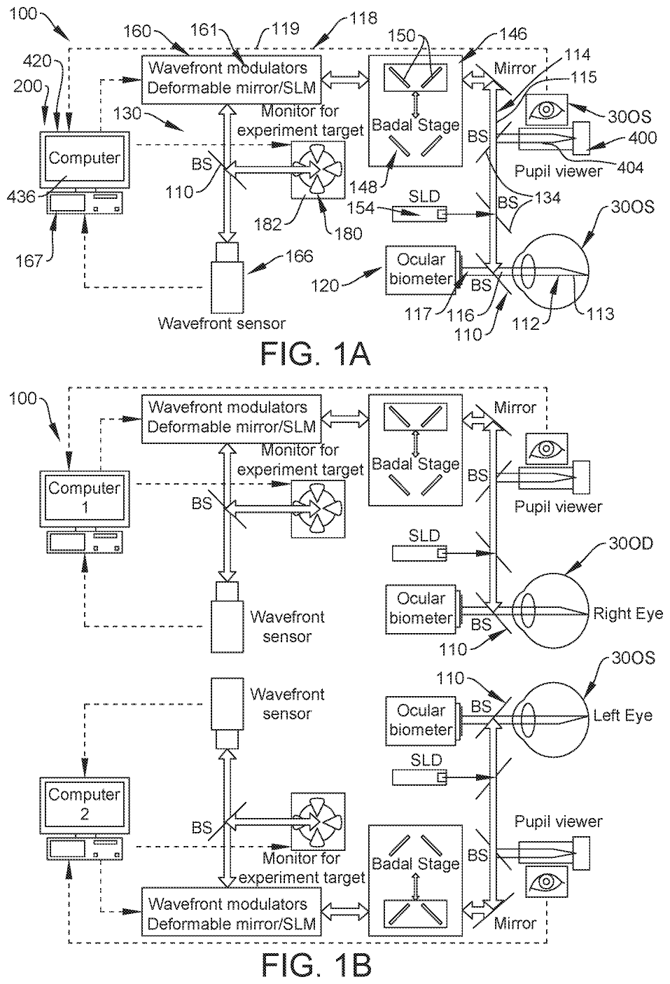

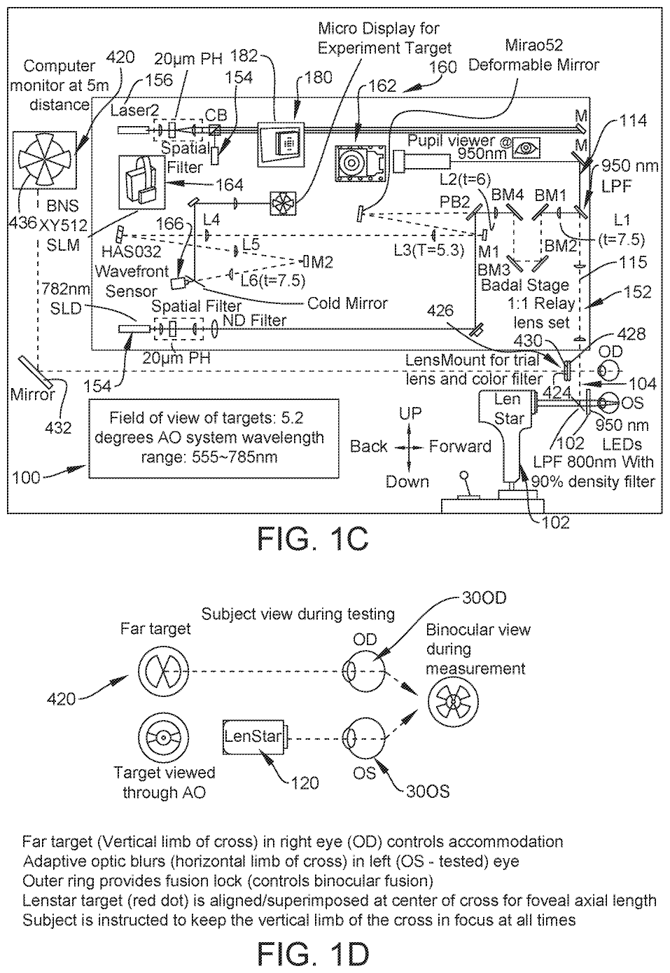

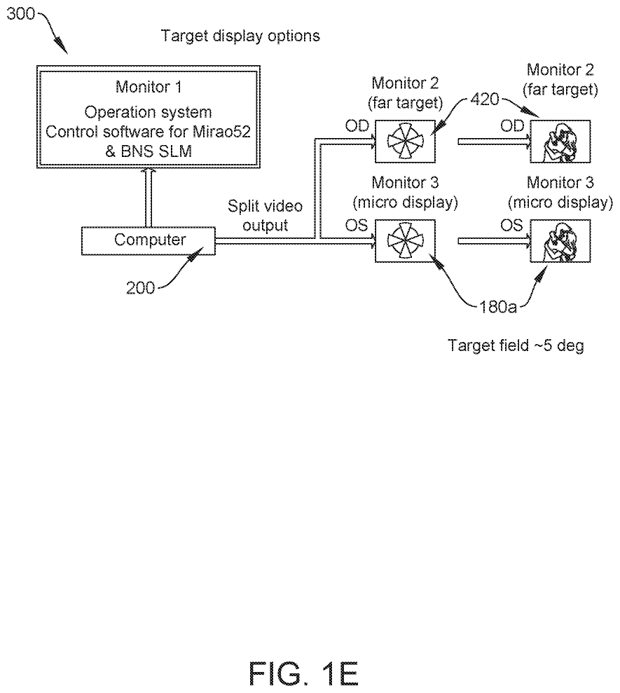

To quantify the visual performance with ophthalmic lens designs, the inventors have provided an adaptive optics apparatus 100 (see FIG. 1A) comprising a viewing channel, so that aspects of vision performance can be measured while the subject views the image or screen target 184 displayed on screen 182 through the optical designs 10 implemented in the adaptive optics device 160.

The embodiment of apparatus 100 for measuring an influence of an ophthalmic lens design shown in FIG. 1A, comprises a beam splitter 110 for splitting the optical light path 112 associated with an eye to be measured 30OS into an adaptive optics light path 114 and a measurement light path 116. While, FIG. 1A shows measurement of the left eye, OS, either the right eye OD or the left eye OS may be the measured eye with the other eye being the fellow eye.

An adaptive optics device 160 is positioned in the adaptive optics light path 114 to receive the optical light path beam 115 and to implement the ophthalmic lens design.

An ocular biometric device 120 is positioned in the ocular biometric measurement light path 116 to obtain biometric data from eye 30OS.

FIG. 1A shows one embodiment of an adaptive optics device 100 according to the invention. FIG. 1B shows one embodiment of a binocular embodiment of an adaptive optics device 100 according to the invention. FIG. 1C shows another embodiment of an adaptive optics device 100 according to the invention that was used to perform the experiments detailed below.

The beam splitter 110 may comprise any suitable device for splitting a light beam into two or more beams. The beam splitter may comprise a pellicle beam splitter, a cube beamsplitter, a dichroic mirror, a band filter or a longpass/shortpass filter.

The biometric device 120 may comprise a non-contact biometric device. The biometric device may comprise an interferometer. The interferometer may comprise a laser interferometer or a low coherence interferometer. The interferometer may comprise an optical biometer or an optical coherence tomographer (OCT).

The biometric data obtained by device 120 may comprise one or more of choroidal thickness; optical axial length (distance from the anterior corneal surface to the retinal pigment epithelium); vitreous chamber depth, anterior chamber depth, crystalline lens thickness, corneal thickness, retinal thickness (or layers within the retina), and scleral thickness. These biometric data may be acquired along any axis of the eye 30OS, but will typically be acquired along the visual axis as the person being tested views the biometric device's fixation target 121 (not shown).

In the embodiment shown in FIG. 1C the biometric device 120 comprises a Lenstar optical biometer. The Lenstar LS 900 120 is a noncontact optical biometer based on the principle of optical low-coherence reflectometry. It provides a comprehensive range of ocular axial biometric measurements including corneal thickness (CT), anterior chamber depth (ACD), lens thickness (LT), and axial length (AxL) [distance from anterior cornea to retinal pigment epithelium]) simultaneously in a single measurement procedure.

To implement the ophthalmic lens design, an adaptive optics device 160 comprises one or more wavefront shapers 161. The one or more wavefront shapers 161 may comprise one or more spatial light modulator 164 and/or one or more adaptive or deformable mirror 162.

Typically, an adaptive or deformable mirror 162 is capable of implementing large stroke changes to a wavefront but lacks detail. A spatial light modulator 164 is theoretically capable of displaying any wavefront shape.

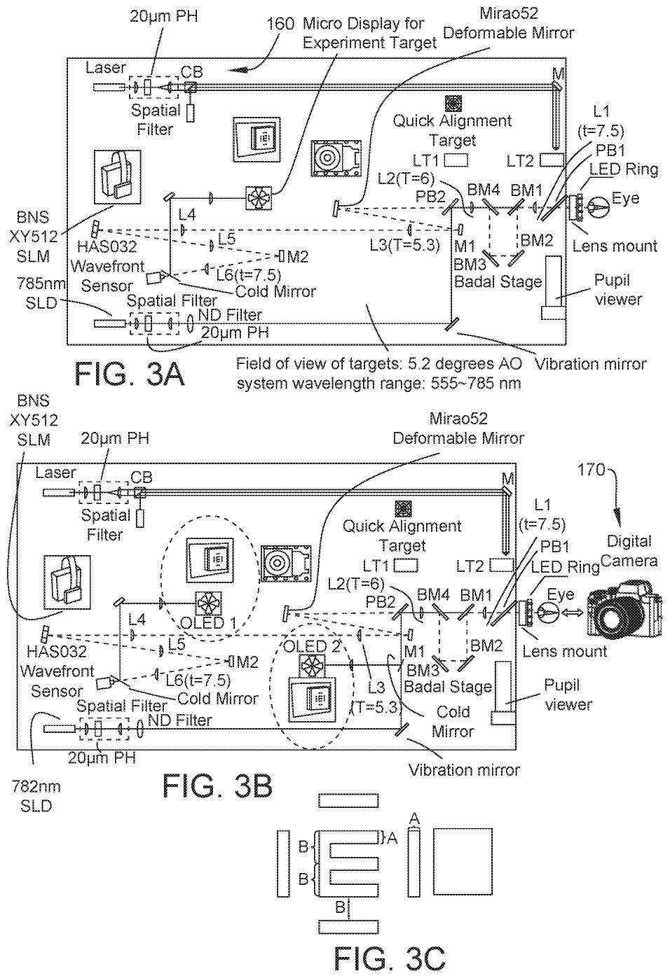

The embodiments shown in FIGS. 1C and 3A comprise one spatial light modulator 164 and one adaptive mirror 162. In other embodiments, apparatus 100 may comprise two or more spatial light modulators 164 and/or two or more adaptive mirrors 162.

The deformable or adaptive mirror 162 recreates the pre-determined wavefront by modifying the surface shape of a deformable membrane 163 (not shown). The adaptive mirror 162 is driven by one or more actuators 169 (not shown) to adjust the shape of the generated wavefront.

The spatial light modulator (SLM) 164 recreates the pre-determined wavefront shape by changing the refractive index and uses a modular method (diffractive optics) to display the wavefront pattern of a high amplitude.

Spatial light modulator 164 is comprised of a liquid crystal layer 165 (not shown) that changes refractive index in response to an array of underlying electrodes (not shown). Spatial light modulator 164 comprises pixels or optical elements of 15×15 microns and a square 7.68×7.68 mm active area.

The adaptive optics device 160 may comprise a single SLM 164 only to shape the wavefront. However, two or more SLMs 164 may be preferred. The inventors hypothesise that multiple SLMs 164 may be used to induce axial changes with different wavelengths. In particular, the axial changes with wavefront modulation of blue light may be induced with a designated SLM 164. The induced axial changes may then be measured with biometric device 120.

Spatial light modulator 164 is operated by a controller 168 (not shown) to adjust the shape of the generated wavefront. The controller 168 is directed by computing device 200. In the embodiments shown in FIGS. 1C and 3A controller 168 comprises a control box connected to the computer by a PCIEX16 slot. From the teaching herein a skilled person is readily able to select other suitable devices for controller 168. In one embodiment, controller 168 may not be comprised in device 100 and the direction of SLM 164 is performed directly by computer 200.

To take advantage of the capabilities of the different wavefront shapers 161, when both a spatial light modulator 164 and a deformable mirror 162 are present, they may be located in series. The embodiments of FIGS. 1C and 3A show the spatial light modulator 164 and the one adaptive mirror 162 located in series.

The apparatus 100 has a field of view of 5.2 degrees and a wavelength range of 555 to 785 nm. The field of view may be increased by modifying the optics of the system 300.

The adaptive optics device 160 further comprises a wavefront sensor 166 for directly measuring the implemented ophthalmic lens design.

The adaptive optics device 160 also comprises a plurality of optical elements 130. The various components of the plurality of optical elements 130 direct the light beams 113, 115, 117. From the teachings herein a skilled person is readily able to select suitable components for the plurality of optical elements 130.

One component of the plurality of optical elements 130 is focus corrector 146 which comprises a Badal stage 148. The Badal stage 148 comprises two or more Badal stage mirrors 150.

The plurality of optical elements 130 may further comprise one or more relay lens set 152; one or more mirrors 136; one or more lenses 132; one or more beam splitters 134; and/or one or more cold mirrors 144.

The adaptive optics device 160 further comprises one or more micro-displays 180. Both a primary micro-display 180a and a secondary micro-display 180b may be present. The primary micro-display 180a may be viewable through the one or more wavefront shapers 161. Each of the plurality of micro-displays 180 may comprise any suitable display such as, an LED or OLED display.

Each of the one or more micro-displays 180 may be individually or collectively synchronised to display vision tests including visual acuity and contrast sensitivity. Each of the one or more micro-displays 180 may also be individually or collectively synchronised to display a movie or collection of images of the viewer's choice.

Each of the one or more micro-displays 180 may display a fine reference scale and/or a grayscale. The grayscale may comprise 256 levels.

The secondary micro-display 180b may be aligned so that the image 184 displayed thereon overlays with an image 184 displayed on the primary micro-display 180a. The images displayed on the secondary micro-display 180b may be under independent optical control.

An image 184 displayed on a micro-display 180 may be manipulated with imposition of an optical design while the image displayed on the secondary display 180b may be used as a reference.

The optical elements 130 may further comprise an objective lens in front of secondary micro-display 180b to produce the same through-system magnification as in the primary micro-display 180a.

Apparatus 100 further comprises a fellow eye 30OD viewer 420 comprising a display 436. The fellow eye 30OD display 436 may be synchronised with one or more micro-displays 180. FIG. 1D shows the subject view during testing without illustrating device 160.

To make fellow eye 30OD viewer 420 visible to eye 30OD, device 100 further comprises fellow eye 30OD optical elements 426, which in the embodiment shown in FIG. 1C comprises lens 428, colour filter 430 and mirror 432. The fellow eye 30OD optical components 426, or a portion thereof, may be comprised in a fellow eye 3OD lens mount 424. Mirror 432 is not located in the lens mount 424 and is located between the fellow eye 30D lens mount 424 and the fellow eye 3OD display 436.

Apparatus 100 further comprises an illumination source 104. In the embodiment shown in FIG. 1C, illumination source 104 comprises a plurality of LEDs 106 arranged in a ring 108.

FIG. 1C also shows a lens mount 102 and a lens 103 positioned adjacent eye 30OS before beam splitter 110.

As shown in FIG. 3B, the adaptive optics device 160 may further comprise an imaging device 170, such as a digital camera, with its image plane conjugate to or replacing the retinal plane of the eye 30OS. Imaging device 170 may be used to replace the eye 30OS when studying the optical design's impact on image quality. Additional optical elements 130 may be added to allow the imaging device 170 to be conjugate with the retinal plane of the eye 30OS whilst being tested.

As shown in FIG. 1A, also comprised in device 160 is a pupil viewer 400, such as a digital camera. The pupil viewer 400 may be positioned in a pupil tracking path 404. The pupil tracking path 404 may comprise one or more pupil tracking beam splitter 134 which may be comprised in optical elements 130. The pupil viewer 400 also comprises a pupil tracker illumination source 406 (not shown). The pupil tracker illumination source 406 illuminates at a near infrared wavelength. The near infrared wavelength may comprise 700 to 2500 nm; 800 to 1100 nm; or 900 to 1000 nm. In one embodiment the near infrared wavelength comprises 950 nm.

The apparatus and system may further comprise a super luminescent diode 154 to illuminate the eye 30OS. The illumination may comprise a spot image on the retina 34 for measurement purposes.

The apparatus 100 and system 300 may further comprise a laser or superluminescent diode to provide illumination for alignment.

Part of system 300 is shown in FIG. 1E. System 300 comprises one or more computing device 200 for controlling the two or more wavefront shapers 161 to produce the ophthalmic lens design and for powering and controlling displays 180a, 180b, 214, 420.

Display 214 displays the graphical user interface for system 300.

Computing device 200 is then connected to primary micro-display 180a in the adaptive optics light path 114 and secondary micro-display 180b and fellow eye 30OD viewer 420 in the clear optics light path 118.

A second output port of the graphic card (not shown) of personal computing device 200 has been split into two channels with the same output (Maltese cross target, a movie or collection of images). By doing this, micro-displays 180a and 180b may be synchronised for the two eyes 30OS, 30OD.

The size, brightness and contrast of micro-displays 180a, 180b may be adjusted to match each other. Secondary micro-display 180b is set to run on non-colour mode which is the same as the primary micro-display 180a.

One embodiment of a method 500 for measuring an influence of ophthalmic lens design according to the invention is shown in FIG. 13. At 502 an optical light path is split into an adaptive optics light path and an ocular biometric measurement light path. At 504 the ophthalmic lens design is implemented in an adaptive optics device positioned in the adaptive optics light path. Then, at 506, biometric data is obtained in the ocular biometric measurement light path to measure the influence of the ophthalmic lens design.

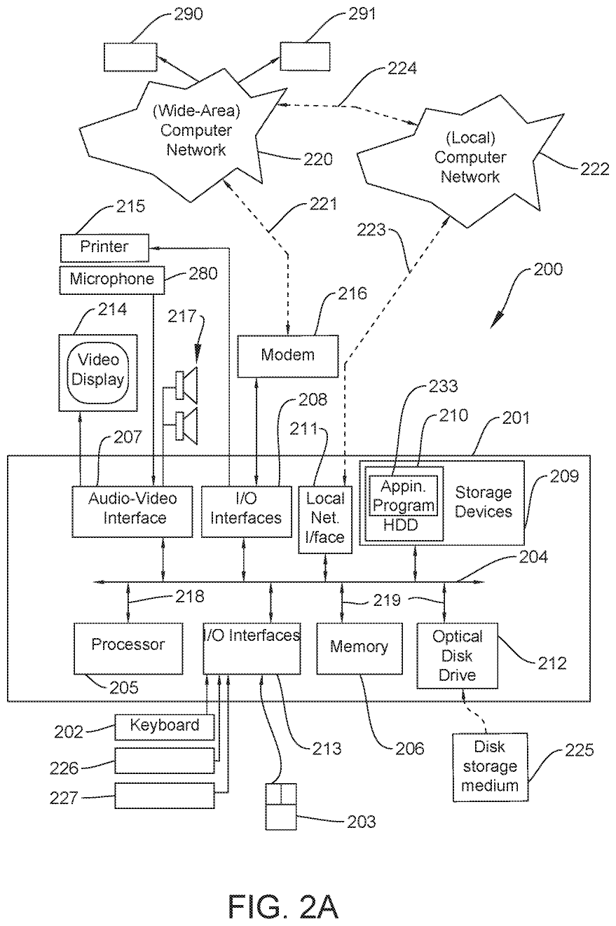

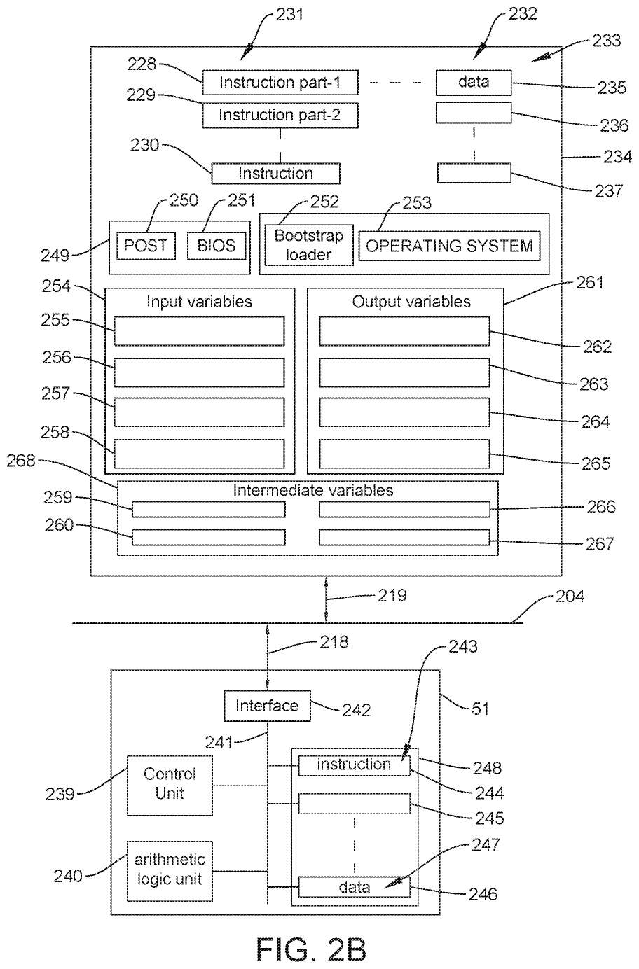

One embodiment of a computing device 200 suitable for use in the present invention is shown in FIGS. 2A and 2B. In the embodiment shown computing device 200 comprises a computer module 201 comprising input devices such as a keyboard 202, a mouse pointer device 203, a scanner 226, an external hard drive 227, and a microphone 280; and output devices including a printer 215, a display device 214 and loudspeakers 217. In some embodiments video display 214 may comprise a touchscreen.

A Modulator-Demodulator (Modem) transceiver device 216 may be used by the computer module 201 for communicating to and from a communications network 220 via a connection 221. The network 220 may be a wide-area network (WAN), such as the Internet, a cellular telecommunications network, or a private WAN. Through the network 220, computer module 201 may be connected to other similar computing devices 290 or server computers 291. Where the connection 221 is a telephone line, the modem 216 may be a traditional “dial-up” modem. Alternatively, where the connection 221 is a high capacity (e.g.: cable) connection, the modem 216 may be a broadband modem. A wireless modem may also be used for wireless connection to network 220.

The computer module 201 typically includes at least one processor 205, and a memory 206 for example formed from semiconductor random access memory (RAM) and semiconductor read only memory (ROM). The module 201 also includes a number of input/output (I/O) interfaces including: an audio-video interface 207 that couples to the video display 214, loudspeakers 217 and microphone 280; an I/O interface 213 for the keyboard 202, mouse 203, scanner 226 and external hard drive 227; and an interface 208 for the external modem 216 and printer 215. In some implementations, modem 216 may be incorporated within the computer module 201, for example within the interface 208. The computer module 201 also has a local network interface 211 which, via a connection 223, permits coupling of the computing device 200 to a local computer network 222, known as a Local Area Network (LAN).

As also illustrated, the local network 222 may also couple to the wide network 220 via a connection 224, which would typically include a so-called “firewall” device or device of similar functionality. The interface 211 may be formed by an Ethernet circuit card, a Bluetooth wireless arrangement or an IEEE 802.11 wireless arrangement or other suitable interface.

The I/0 interfaces 208 and 213 may afford either or both of serial and parallel connectivity, the former typically being implemented according to the Universal Serial Bus (USB) standards and having corresponding USB connectors (not illustrated).

Storage devices 209 are provided and typically include a hard disk drive (HDD) 210. Other storage devices such as, an external HD 227, a USB-RAM drive (not shown), memory cards (not shown), a disk drive (not shown) and a magnetic tape drive (not shown) may also be used. An optical disk drive 212 is typically provided to act as a non-volatile source of data. Portable memory devices, such as optical disks (e.g.: CD-ROM, DVD, Blu-Ray Disc), USB-RAM, external hard drives and floppy disks for example, may be used as appropriate sources of data to the computing device 200. Another source of data to computing device 200 is provided by the at least one server computer 291 through network 220.

The components 205 to 213 of the computer module 201 typically communicate via an interconnected bus 204 in a manner that results in a conventional mode of operation of computing device 200. In the embodiment shown in FIGS. 2A and 2B, processor 205 is coupled to system bus 204 through connections 218 Similarly, memory 206 and optical disk drive 212 are coupled to the system bus 204 by connections 219. Examples of computing devices 200 on which the described arrangements can be practiced include IBM-PC's and compatibles, Sun Sparc stations, Apple computers; smart phones; tablet computers or like a device comprising a computer module like computer module 201. It is to be understood that when computing device 200 comprises a smart phone or a tablet computer, display device 214 may comprise a touchscreen and other input and output devices may not be included such as, mouse pointer device 201; keyboard 202; scanner 226; and printer 215.

FIG. 2B is a detailed schematic block diagram of processor 205 and a memory 234. The memory 234 represents a logical aggregation of all the memory modules, including the storage device 209 and semiconductor memory 206, which can be accessed by the computer module 201 in FIG. 2A.

The methods of the invention may be implemented using computing device 200 wherein the methods may be implemented as one or more software application programs 233 executable within computer module 201. In particular, the steps of the methods of the invention may be effected by instructions 231 in the software carried out within the computer module 201

The software instructions 231 may be formed as one or more code modules, each for performing one or more particular tasks. The software 233 may also be divided into two separate parts, in which a first part and the corresponding code modules performs the method of the invention and a second part and the corresponding code modules manage a graphical user interface between the first part and the user.

The software 233 may be stored in a computer readable medium, including in a storage device of a type described herein. The software is loaded into the computing device 200 from the computer readable medium or through network 221 or 223, and then executed by computing device 200. In one example the software 233 is stored on storage medium 225 that is read by optical disk drive 212. Software 233 is typically stored in the HDD 210 or the memory 206.

A computer readable medium having such software 233 or computer program recorded on it is a computer program product. The use of the computer program product in the computing device 200 preferably affects a device or apparatus for implementing the methods of the invention.

In some instances, the software application programs 233 may be supplied to the user encoded on one or more disk storage medium 225 such as a CD-ROM, DVD or Blu-Ray disc, and read via the corresponding drive 212, or alternatively may be read by the user from the networks 220 or 222. Still further, the software can also be loaded into the computing device 200 from other computer readable media. Computer readable storage media refers to any non-transitory tangible storage medium that provides recorded instructions and/or data to the computer module 201 or computing device 200 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of software application programs 233, instructions 231 and/or data to the computer module 201 include radio or infra-red transmission channels as well as a network connection 221, 223, 334, to another computer or networked device 290, 291 and the Internet or an Intranet including email transmissions and information recorded on Websites and the like.

The second part of the application programs 233 and the corresponding code modules mentioned above may be executed to implement one or more graphical user interfaces (GUIs) to be rendered or otherwise represented upon display 214. Through manipulation of, typically, keyboard 202, mouse 203 and/or screen 214 when comprising a touchscreen, a user of computing device 200 and the methods of the invention may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers 217 and user voice commands input via microphone 280. The manipulations including mouse clicks, screen touches, speech prompts and/or user voice commands may be transmitted via network 220 or 222.

When the computer module 201 is initially powered up, a power-on self-test (POST) program 250 may execute. The POST program 250 is typically stored in a ROM 249 of the semiconductor memory 206. A hardware device such as the ROM 249 is sometimes referred to as firmware. The POST program 250 examines hardware within the computer module 201 to ensure proper functioning, and typically checks processor 205, memory 234 (209, 206), and a basic input-output systems software (BIOS) module 251, also typically stored in ROM 249, for correct operation. Once the POST program 250 has run successfully, BIOS 251 activates hard disk drive 210. Activation of hard disk drive 210 causes a bootstrap loader program 252 that is resident on hard disk drive 210 to execute via processor 205. This loads an operating system 253 into RAM memory 206 upon which operating system 253 commences operation. Operating system 253 is a system level application, executable by processor 205, to fulfil various high level functions, including processor management, memory management, device management, storage management, software application interface, and generic user interface.

Operating system 253 manages memory 234 (209, 206) in order to ensure that each process or application running on computer module 201 has sufficient memory in which to execute without colliding with memory allocated to another process. Furthermore, the different types of memory available in the computing device 200 must be used properly so that each process can run effectively. Accordingly, the aggregated memory 234 is not intended to illustrate how particular segments of memory are allocated, but rather to provide a general view of the memory accessible by computer module 201 and how such is used.

Processor 205 includes a number of functional modules including a control unit 239, an arithmetic logic unit (ALU) 240, and a local or internal memory 248, sometimes called a cache memory. The cache memory 248 typically includes a number of storage registers 244, 245, 246 in a register section storing data 247. One or more internal busses 241 functionally interconnect these functional modules. The processor 205 typically also has one or more interfaces 242 for communicating with external devices via the system bus 204, using a connection 218. The memory 234 is connected to the bus 204 by connection 219.

Application program 233 includes a sequence of instructions 231 that may include conditional branch and loop instructions. Program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, processor 205 is given a set of instructions 243 which are executed therein. The processor 205 then waits for a subsequent input, to which processor 205 reacts by executing another set of instructions. Each input may be provided from one or more of a number of sources, including data generated by one or more of the input devices 202, 203, or 214 when comprising a touchscreen, data received from an external source across one of the networks 220, 222, data retrieved from one of the storage devices 206, 209 or data retrieved from a storage medium 225 inserted into the corresponding reader 212. The execution of a set of the instructions may in some cases result in output of data. Execution may also involve storing data or variables to the memory 234.

The disclosed arrangements use input variables 254 that are stored in the memory 234 in corresponding memory locations 255, 256, 257, 258. The described arrangements produce output variables 261 that are stored in the memory 234 in corresponding memory locations 262, 263, 264, 265. Intermediate variables 268 may be stored in memory locations 259, 260, 266 and 267.

The register section 244, 245, 246, the arithmetic logic unit (ALU) 240, and the control unit 239 of the processor 205 work together to perform sequences of micro-operations needed to perform “fetch, decode, and execute” cycles for every instruction in the instruction set making up the program 233. Each fetch, decode, and execute cycle comprises:

(a) a fetch operation, which fetches or reads an instruction 231 from memory location 228, 229, 230;

(b) a decode operation in which control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the methods of the invention may be associated with one or more segments of the program 233, and may be performed by register section 244-246, the ALU 240, and the control unit 239 in the processor 205 working together to perform the fetch, decode, and execute cycles for every instruction in the instruction set for the noted segments of program 233.

One or more other computers 290 may be connected to the communications network 220 as seen in FIG. 2A. Each such computer 290 may have a similar configuration to the computer module 201 and corresponding peripherals.

One or more other server computers 291 may be connected to the communications network 220. These server computers 291 respond to requests from the personal device or other server computers to provide information.

Method 500 may alternatively be implemented in dedicated hardware such as one or more integrated circuits performing the functions or sub functions of the described methods. Such dedicated hardware may include graphic processors, digital signal processors, or one or more microprocessors and associated memories.

Software 233 and processor 205 may operate on deformable mirror 162 and spatial light modulator 164 to quickly implement and test optical designs without the need to fabricate lenses.

The invention provides an ophthalmic lens comprising the ophthalmic lens design implemented according to the method 500 of the invention.

Further, the invention provides a method for optimising a lens design using the method 500, the apparatus 100 and/or the system 300 of the invention. The invention additionally provides an ophthalmic lens comprising the optimised lens design.

### EXAMPLES

### Adaptive Optics System for Testing of Visual Acuity and Contrast Sensitivity

The optical layout of the adaptive optics (AO) device 160 for the testing of visual performance according to one embodiment of the invention is shown in FIG. 3A. The integration of device 160 into apparatus 100 according to various embodiments of the invention is shown in FIGS. 1A, 1B and 1C. The primary micro-display 180a comprising screen 182 was programmed to display vision tests including visual acuity and contrast sensitivity.

Customized software based on a staircase algorithm was used to control the size of an E target 20 (see FIG. 3C) to test visual acuity, or the contrast level of the ‘E’ target 20 was varied to measure contrast threshold. The task for the subject was a four alternative choice with the subject pressing a keypad button to indicate if the E target 20 was oriented up, down, left or right. The staircase algorithm then incremented the size or contrast of the E target 20 based on the subject's correct or incorrect response to estimate the threshold resolution. Between target presentations, screen 182 displayed a mask 20b of grey random noise with an equal average contrast to the E target 20. This is a psychophysical technique to minimize adaptation effects and afterimages between presentations. The E target 20 was surrounded by flanking bars 20c that provided a lateral interaction similar to lines of letters displayed on letter acuity charts.

### Testing Visual Acuity

The Tumbling E test target 20 was used in the adaptive optics device 160 to test high contrast photopic visual acuity with applied lens designs (two-zone, centre-distance concentric bifocals). Visual acuity was tested without any time limit Eight healthy young subjects participated. Measurements were only performed in the left eye 30OS.

As a baseline measurement visual acuity was also measured with the subject's best distance sphero-cylinder correction.

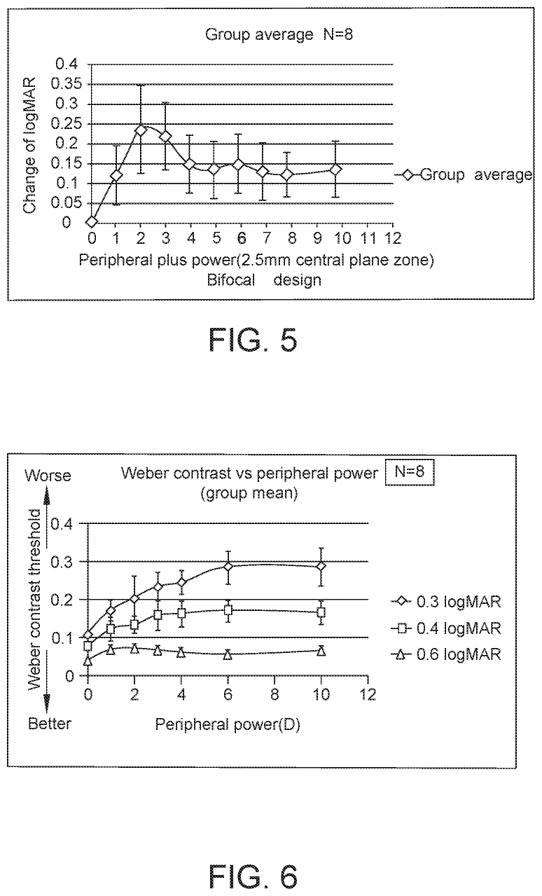

As shown in FIG. 5, increasing peripheral power +2D caused a loss of high contrast visual acuity. However as the peripheral power continued to increase, the relative effect on visual acuity plateaus, so that by +4D peripheral plus, the visual acuity loss becomes relatively constant.

Testing Contrast Sensitivity with Applied Designs

The aim of this study was to test the effect of applied lens designs on contrast sensitivity.

All four subjects were given a ten minute practice section on the device 160 with the contrast sensitivity test. After the subjects became familiar with the testing procedure, the experimental operator induced the applied lens designs of different level of plus power to the subject's left eye 30OS. The order of testing was randomized. During testing, the subjects viewed an ‘E’ target 20 of fixed sizes displayed on the OLED micro-display 180a and performed the CS test without time limits

The task was a four alternative choice with the subject pressing a keypad button to indicate if the E target 20 was oriented up, down, left or right. In this experiment, CS tests were performed on the subjects with three different letter sizes of 0.3, 0.4 and 0.6 logMAR.

Increasing the peripheral power decreased the subject's contrast sensitivity (i.e. a higher contrast threshold).

As shown in FIG. 6, unlike the VA (Visual Acuity) results, the CS (Contrast Sensitivity) were further reduced as higher amounts of plus power up to +6D were used in the peripheral zone.

Peripheral plus power showed a stronger effect on CS when the subject was viewing targets 20 with higher spatial frequency content (smaller letter sizes of 0.3 and 0.4 logMAR).

### Secondary Micro-Display

As shown in FIG. 3B a secondary micro-display 180b with the same specifications as micro-display 180a was added to adaptive optics device 160. The secondary micro-display 180b was linked with the system axis by optical elements 130 comprising lenses 132, cold mirrors 144 and pellicle beamsplitters (PB2) 134.

The objective lens 132 in front of secondary micro-display 180b was chosen to produce the same through-system magnification as micro-display 180a.

The modified system 160 uses two micro-displays 180a and 180b aligned so that the images or screen targets 184a and 184b displayed thereon overlay each other, but each screen target 184a and 184b is under independent optical control.

Integration of Adaptive Optics System with Simultaneous Measurements of Choroidal Response

An adaptive optics device 160 comprising an adaptive or deformable mirror 162 and spatial light modulator 164 was combined with an ocular biometric device 120 to simultaneously test the effect of experimental lens designs on axial length/choroidal thickness at regular intervals during exposure to the optical design and again during the recovery period after exposure to the optical design had ceased. Advantageously, this approach provided the opportunity to test new optical designs without the need to manufacture the ophthalmic lenses.

Studies of the optical designs have been systematically varied in the adaptive optics device 160, including parameters such as, location and area of the plus optical power in relation to lens centre and the progression of power (rate of change). Measurements of choroidal thickness and axial length were performed simultaneously when the subject is viewing through the ophthalmic lens design induced by the adaptive optics device 160. Various retinal locations can be measured including at the fovea and at various locations in the retinal periphery.

The adaptive optics device 160 for basic vision research comprises the primary components of a Mirao adaptive mirror 162 and HASO Hartmann Shack wavefront sensor 166. The Mirao adaptive mirror 162 can be accurately calibrated to produce aberrations such as spherical aberration. However because the adaptive mirror 162 is driven by fifty-two actuators 169 (not shown) it has limited ability to produce optical designs with steep gradients of power.

To provide a device 160 with the capacity to simulate a wide range of challenging optical designs, a spatial light modulator 164 was added. In this embodiment, the SLM 164 was obtained from Boulder Nonlinear Systems Inc. Designs to produce abrupt power changes such as two zone concentric bifocals with a +10D peripheral zone.

As shown in FIGS. 1C and 3A the SLM 164 was integrated into adaptive optics device 160 in series with the existing adaptive or deformable mirror 162. Advantageously, this results in the power of both adaptive optics elements to create a wide range of optical designs.

The spatial light modulator 164 is composed of a liquid crystal 165 (not shown) layer that changes refractive index in response to an array of underlying electrodes 171 with a liquid crystal pixel/element size of 15×15 microns across a square 7.68×7.68 mm active area.

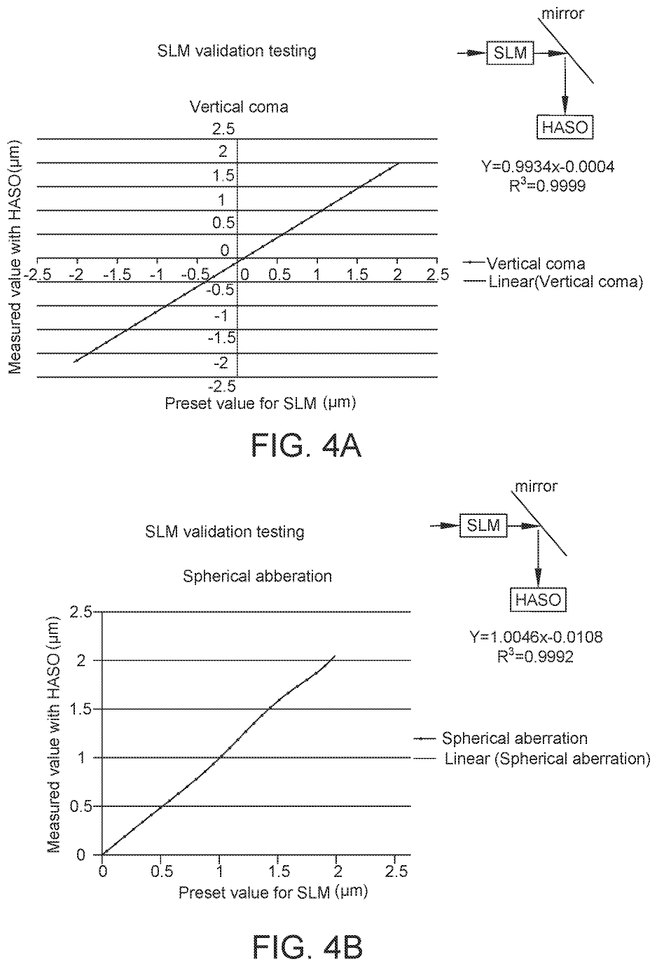

Validation testing of the adaptive optics device 160 output was conducted with a variety of optical designs. As shown in FIGS. 4A and 4B, both vertical coma and spherical aberration were accurately implemented in the spatial light modulator 164, when directly measured using the HASO wavefront sensor 166. The adaptive optics device 160 combining the adaptive mirror 162 and spatial light modulator 164 has provided the capacity to quickly produce complex optical designs and then to reliably test a range of aspects of visual performance and axial length and or choroidal response.

Development of the Combined Adaptive Optics Stimulus System with Simultaneous Measurements of Axial Length/Choroidal Thickness

To test the response of the axial length 38 of the eye 30OS to optical designs with the adaptive optics device 160 required a series of developments. These issues included:
1. How to control the accommodation response of the tested eye.
2. How to measure the axial length of the eye while simultaneously exposing the eye to the optical design.
3. What visual task would the subject undertake while viewing through the optics for up to an hour.
4. How to maintain the subject aligned within the optical system for up to an hour of continuous testing.

The apparatus 100 used is illustrated in the FIGS. 1A, 1B, 1C and FIG. 3A, 3B and allows the control of accommodation and simultaneous viewing of the measurement light path 116 and the adaptive optics light path 114. If the fellow eye 30OD is occluded and the tested eye 30OS views target 182, the tested eye 30OS will accommodate based on the optical design generated by the adaptive optics system 160 and the Badal lens system settings. For example, this can range from zero accommodation demand (far viewing) to a high level of accommodation demand (e.g. 5 D) to simulate near viewing at 20 cm.

Accommodation can also be controlled by using the fellow non-tested eye 30OD to focus on a target 184b as shown in FIG. 1C. If this target 184b viewed by the fellow eye 3OD is clear, it will dominate the accommodation response of the two eyes 30OS, 30OD (the tested eye 30OS may be blurred by the optical design under test).

Accommodation response of the tested eye 30OS can be checked with the HASO wavefront sensor 166 at any time during the testing period. By using a beam splitter 134 between the tested eye 30OS and the biometric device 120, the tested eye 30OS can simultaneously view the ocular biometric measurement light path 116 of the biometric device 120 and the screen target 184a.

The subject is required to view a target 184 through the adaptive optics device 160 for up to an hour. During measurements of axial length 38 with the Lenstar 120 this process requires accurate and steady fixation so as to align the measurement light beam 117 of the Lenstar 120 with the foveal axis of the tested eye 30OS. To ensure steady fixation a Maltese cross target 20 was presented as a screen target 184 on a micro-display screen 182 and the centre of the measurement beam 117 (appears to the subject as a red dot) was aligned via joystick control with the centre of the Maltese cross displayed on micro-display 180a. The beam splitter 110 before the Lenstar 120 allows the subject to see both the micro-display 180a and the Lenstar measurement light beam 117 simultaneously.

If accommodation control is also required with the fellow eye 30OD, then the fellow eye 30OD viewer 420 is synchronized to the tested eye micro-display 180a and both eyes 30OS and 30OD see elements of the cross pattern simultaneously (this is called dichoptic viewing where both eyes see similar aspects of a scene, but presented through different optical paths).

Since viewing the Maltese cross pattern or a static image for up to an hour in the adaptive optics system 160 is tedious, the micro-display 180a and far target monitor/fellow eye 30OD viewer 420 are used to synchronously present a movie of the subject's choice. The subject then sees the movie through the ophthalmic test design via the adaptive optics affecting the tested eye 30OS with the fellow eye 3OD occluded. Alternately the movie can be viewed by both eyes 30OD and 30OS, with the ophthalmic test design affecting the image seen with the tested eye 30OS that is viewing via the adaptive optics device 160, while the fellow eye 30OD can be optimally corrected for clear vision. This arrangement is shown in FIG. 1E and illustrates computer 200 that may be used to control deformable mirror 162 and the spatial light modulator 164.

When the subject views the micro-display target 184 through the adaptive optics device 160 it is important that they remain steady and the pupil 32 remains well centered with respect to the optical light path 112 of the adaptive optics device 160. Since the myopia control optical designs often have rapid power changes across the pupil 32, misalignment of the optics can substantially change the type and level of the components of the test wavefront.

To minimize this problem of patient and pupil misalignment, the inventors developed a pupil tracker 400 comprising a pupil tracker path 404 in the adaptive optics device 160 that provides real time feedback to the computing device then to the controller 168 for the spatial light modulator 164. The pupil tracker illumination source 406 was chosen as 950 nm (near infrared) so as to not be visible to the subject and therefore not to cause pupil constriction.

The pupil tracking camera 402 provides tracking of the centre of the pupil 32 at a frequency of 30 Hz that is sent to the spatial light modulator controller 168. The controller 168 then adjusts the position of the wavefront generated by the spatial light modulator 164 on its active surface in real time, so that the wavefront (test optical design) essentially moves with the eye 30OS to stay centered on the pupil 32. In this way, over the course of an hour of testing, the subject can move slightly during the testing and still be exposed to the appropriate optical wavefront.

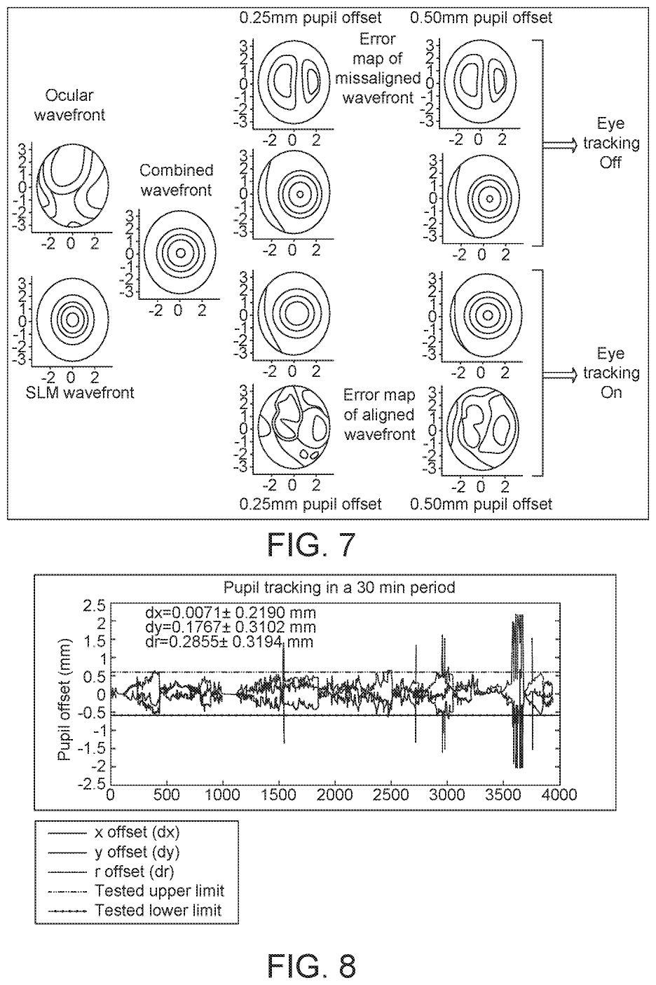

The effect of pupil tracking and re-centering the wavefront pattern with the subject's pupil 32 is shown in FIG. 7. In both examples of 0.25 mm and 0.50 mm pupil offset, the SLM re-centered the wavefront of the applied optical design to the subject's pupil 32, resulting in a much lower amount of residual wavefront error, compared to the results without pupil tracking.

FIG. 8 shows the pupil location of a subject over a 30 min period when viewing a Maltese cross target through the system 300. A heavy and steady headrest with a chinrest and headband is used without the use of a bite bar.

The repeatability of results was tested through the adaptive optics device 160 with four optical conditions (+3D defocus, −3D defocus, +3D longitudinal spherical aberration and −3D longitudinal spherical aberration) over 40 minutes testing. The same subject completed all four optical conditions on two occasions, once using the Maltese cross as fixation target 184 for 40 minutes and again watching a movie throughout the test for 40 minutes. Whenever axial length measurements were taken, the movie was switched to back to the Maltese cross to ensure steady fixation.

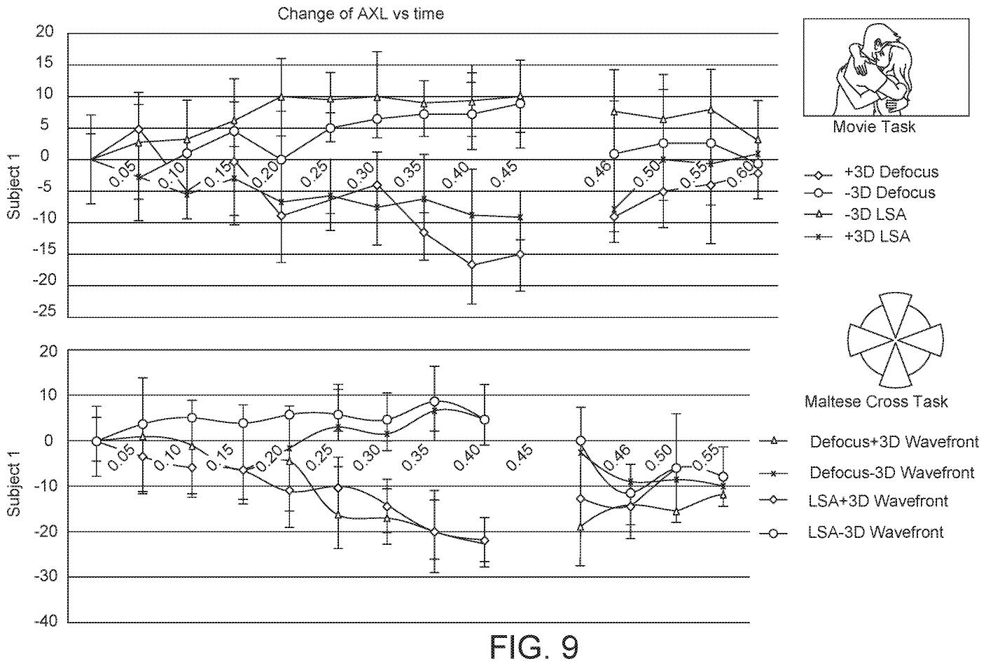

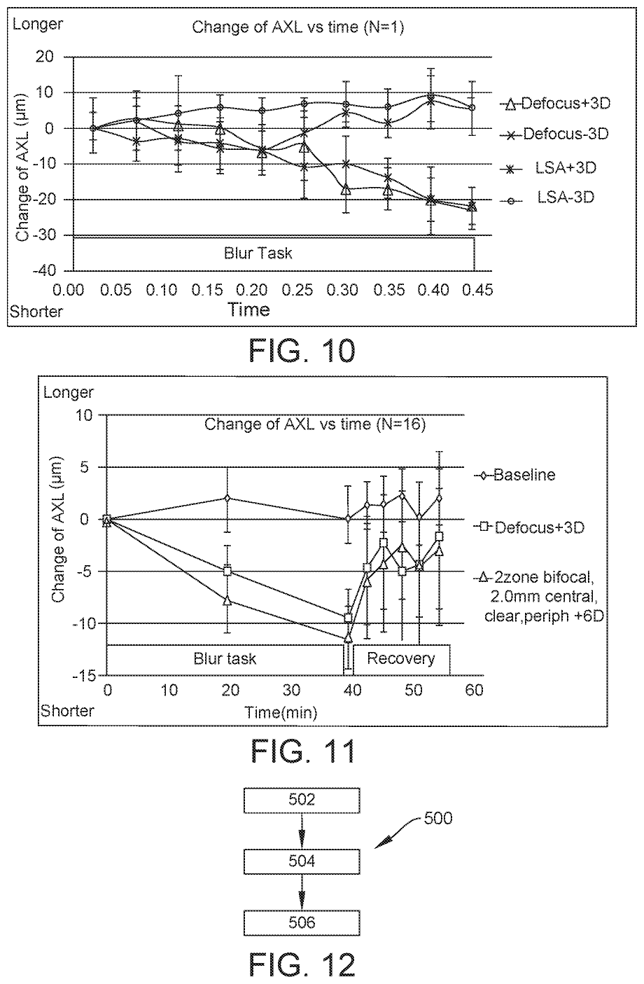

The results in FIGS. 9 and 10 show a good correlation between changes in axial length 38 in both testing conditions. The minus defocus and minus spherical aberration both cause the tested eye 30OS to get longer and the positive defocus and positive spherical aberration both cause the tested eye 30OS to shorten.

Axial Length Measurements with the Lenstar LS900

To determine the geometric distances between peaks in the A-scan, the Lenstar instrument 120 converts optical path lengths into geometric lengths, using assumed refractive indices of the ocular media. The axial resolution is about ten microns for a single A-scan.

An A-scan from a single measurement from a typical subject using Lenstar instrument 120 allows a range of ocular biometric dimensions to be derived from each measurement. A total of five measurements were typically taken and the results later averaged. Following data collection, the A-scan data originating from the posterior eye from each measurement can be manually analysed using the instrument's software to determine the retinal and choroidal thickness. However, choroidal thickness can be accurately derived from spectral domain optical coherence tomography scans with a resolution of about 4-5 microns.

### Optimal Subject Testing Conditions to Understand the Effect of Optical Designs on Axial Length/Choroidal Response

Studies with the adaptive optics device 160 concentrated on understanding the appropriate time period required for “washout” of the effects of prior visual tasks and the prior environment on the outcomes with optical designs viewed through the adaptive optics device 160. Studies by the inventors have shown that accommodation causes the choroid 40 to thin slightly and the axial length 38 to increase (during accommodation), with a regression of about five minutes after ten minutes of accommodation. Other factors thought to influence the choroid thickness 42 are certain medications, nicotine, and caffeine.

The inventors used a washout period of twenty minutes before exposure to the optical designs is commenced. During this time the subjects sit in a room in low illumination with optimal refractive correction being worn and watch TV at a far accommodation distance of 6 m, to relax accommodation and to adapt the retina 34 to the room illuminance. Subjects are routinely questioned about their medication, caffeine and nicotine use.

Since the human eye shows diurnal variation in axial length 38 and choroidal thickness 42 (the eye is longest and the choroid thinnest at around noon), the inventors endeavour to always test subjects at the same time of day to avoid confounding effects from underlying diurnal rhythms.

### Adaptive Optics Study of Concentric Design

The purpose of this study was to investigate the time course and magnitude of changes of axial length 38 under the influence of a concentric bifocal ophthalmic design, and +3D spherical defocus introduced to the eye 30OS by means of adaptive optics.

All subjects were tested with both defocus conditions. The subjects were masked to the type of defocus used in each trial.

Sixteen young (aged 18-30 years) healthy adults were recruited. The optical defocus conditions were tested on different days and at approximately the same of the day to minimize the influence of diurnal variations on axial length.

After a 40 min exposure to the different positive defocus conditions (+3D defocus and the concentric bifocal), significant change (shortening of about 10 microns) in axial length (AxL) 38 was observed. Subjects showed a similar shortening response to both the +3D defocus and concentric bifocal (2 mm central plano zone with +6D periphery). Once exposure to the +3D defocus or concentric bifocal conditions via the adaptive optics are stopped at 40 minutes and the optical correction of the eye is now optimally in focus, the axial length of the eye begins to recover towards its original baseline levels over the next 15 minutes. Results are shown in FIG. 11.

The changes in axial length 38 suggests that the eye is capable of rapidly (within 40 mins) detecting the optical blur introduced via the adaptive optics and altering its axial length.

The present invention has shown that within forty minutes, the eye shows reliable changes in its axial length 38 which allows the development of an understanding of the lens design features which are detected by the tested eye 30OS to adjust short-term eye length.

Advantageously, the present invention overcomes the need to manufacture test ophthalmic lenses and through the pupil tracking software function, allows the optical design to be consistently located coincident with the centre of the pupil.

The findings herein have provided important guidance for the development of a model to guide the optimization of ophthalmic lens designs to potentially control long term eye growth.

In this specification, the terms “comprises”, “comprising” or similar terms are intended to mean a non-exclusive inclusion, such that an apparatus that comprises a list of elements does not include those elements solely, but may well include other elements not listed.

Throughout the specification the aim has been to describe the invention without limiting the invention to any one embodiment or specific collection of features. Persons skilled in the relevant art may realize variations from the specific embodiments that will nonetheless fall within the scope of the invention.

1.-22. (canceled)

23. A method for measuring an influence of an ophthalmic lens design comprising:
splitting an optical light beam into a wavefront measurement light path and a wavefront modulation light path;
implementing the ophthalmic lens design in an adaptive optics device positioned in the wavefront modulation light path; and
obtaining ocular biometric data of the influence of the ophthalmic lens design in an ocular biometric light path to measure the influence of the ophthalmic lens design.

24. The method of claim 23, wherein the adaptive optics device comprises one or more wavefront shapers.

25. The method of claim 24, wherein the one or more wavefront shapers comprise one or more spatial light modulators and/or one or more adaptive mirrors.

26. The method of claim 25, wherein the one or more spatial light modulators comprise a liquid crystal layer that changes refractive index for optical modulation, in response to an array of underlying electrodes.

27. The method of claim 25, wherein the one or more adaptive mirrors are driven by one or more actuators to adjust the shape of a generated wavefront.

28. The method of claim 24, wherein the one or more wavefront shapers comprise one or more spatial light modular in series or the one or more wavefront shapers comprise one or more spatial light modulator in combination with one or more adaptive mirrors.

29. The method of claim 23, wherein the adaptive optics device further comprises a wavefront sensor.

30. An apparatus for measuring an influence of an ophthalmic lens design comprising:
a beam splitter which splits an optical light path into a wavefront measurement light path and a wavefront modulation light path;
an adaptive optics device positioned in the wavefront modulation light path to implement the ophthalmic lens design; and
an ocular biometric device positioned in an ocular biometric measurement light path to obtain ocular biometric data of the influence of the ophthalmic lens design.

31. A method for assembling the apparatus of claim 30, the method comprising:
installing a beam splitter to split an optical light path into a wavefront measurement light path and a wavefront modulation light path;
positioning an adaptive optics device in the wavefront modulation light path to implement the ophthalmic lens design; and
positioning an ocular biometric device in the ocular biometric measurement light path to obtain ocular biometric data.

32. The apparatus of claim 30, wherein the adaptive optics device comprises one or more wavefront shapers.

33. The apparatus of claim 32, wherein the one or more wavefront shapers comprise one or more spatial light modulators and/or one or more adaptive mirrors.

34. The apparatus of claim 33, wherein the one or more spatial light modulators comprise a liquid crystal layer that changes refractive index for optical modulation, in response to an array of underlying electrodes.

35. The apparatus of claim 33, wherein the one or more adaptive mirrors are driven by one or more actuators to adjust the shape of a generated wavefront.

36. The apparatus of claim 32, wherein the one or more wavefront shapers comprise one or more spatial light modulars in series or the one or more wavefront shapers comprise one or more spatial light modulators in combination with one or more adaptive mirrors.

37. The apparatus of claim 30, wherein the adaptive optics device further comprises a wavefront sensor.

38. A system for measuring an influence of an ophthalmic lens design comprising:
a beam splitter for splitting an optical light path into a wavefront modulation light path and a wavefront measurement light path;
an adaptive optics device positioned in the wavefront modulation light path;
one or more processors for controlling the adaptive optics device to implement the ophthalmic lens design; and
an ocular biometric device positioned in an ocular biometric measurement light path for obtaining ocular biometric data of the influence of the ophthalmic lens design.

39. A method for assembling the system of claim 38, the method comprising:
installing a beam splitter to split an optical light path into a wavefront measurement light path and a wavefront modulation light path;
positioning an adaptive optics device in the wavefront modulation light path to implement the ophthalmic lens design;
connecting one or more processor to control the adaptive optics device to implement the ophthalmic lens design; and
positioning an ocular biometric device in the ocular biometric measurement light path to obtain ocular biometric data.

40. The system of claim 38, wherein the adaptive optics device comprises one or more wavefront shapers.

41. The system of claim 40, wherein the one or more wavefront shapers comprise one or more spatial light modulators and/or one or more adaptive mirrors.

42. The system of claim 41, wherein the one or more spatial light modulators comprise a liquid crystal layer that changes refractive index for optical modulation, in response to an array of underlying electrodes.

43. The system of claim 41, wherein the one or more adaptive mirrors are driven by one or more actuators to adjust the shape of a generated wavefront.

44. The system of claim 40, wherein the one or more wavefront shapers comprise one or more spatial light modulars in series or wherein the one or more wavefront shapers comprise one or more spatial light modulators in combination with one or more adaptive mirrors.

45. The system of claim 38, wherein the adaptive optics device further comprises a wavefront sensor.

46. An ophthalmic lens comprising the ophthalmic lens design implemented according to the method of claim 1.
